(19) United States
(12) Patent Application Publication
(10) Pub. No.: US 2002/0113701 A1
(43) Pub. Date: Aug. 22, 2002

(54) Safety tumbler for a door, flap or the like

(76) Inventor: Stephan Turk, Wuppertal (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/076,293

(22) Filed: Feb. 14, 2002

(30) Foreign Application Priority Data
Feb. 17, 2001 (DE) 201 02 819.0

(51) Int. Cl. E05B 45/06

(52) U.S. Cl. 340/542; 340/540

(57) ABSTRACT

The invention concerns a Safety tumbler for a member movable between a closed and an open position, said tumbler comprising a housing with at least one safety switch provided with an actuator and a locking element whose locking function can be activated via a drive triggerable by a control system via a triggering signal, and further comprising at least one signal transmitter which detects the position of the actuator, and at least one signal transmitter which detects the position of the drive and/or of the locking element for the purpose of producing corresponding two-channel signals, wherein an electric interface circuit is provided in the housing for connection to a data bus, the interface circuit converting the signals from the signal transmitters into the data protocol of the data bus (10) and generating the triggering signal from the data protocol of the data bus (10).

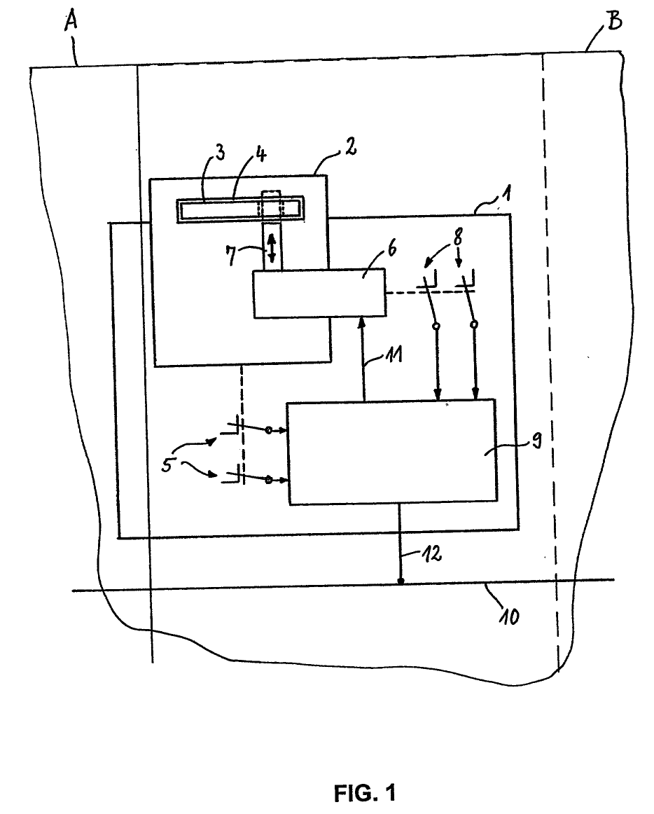

### FIELD OF THE INVENTION

The invention relates to a safety tumbler for a door, flap or the like as it us used in order to protect people from hazardous movements of machines, safety tumblers comprising safety switches are used on doors, flaps or the like so that the doors, flaps or the like can only be opened and/or closed under certain circumstances. The said safety tumblers have the object of preventing the door, flap or the like from being able to be opened if a risk of injury could originate from the movement behind the door, flap or the like.

### DESCRIPTION OF THE RELATED ART

Safety tumblers of this type are conventionally wired into a safety control system of a machine using terminals and/or plugs. By this means, in general for each signal which the safety tumbler exchanges with its surroundings, two electrical conductors are connected to the safety tumbler and are connected to the control system or safety control system of the machine. This type of wiring is complicated and expensive.

### SUMMARY OF THE INVENTION

An object of the invention is therefore to provide a safety tumbler which makes possible less complicated and therefore less expensive wiring.

Thus, the invention concerns a safety tumbler for a member movable between a closed and an open position, said tumbler comprising:

a housing with at least one safety switch provided with an actuator and a locking element whose locking function can be activated via a drive triggerable by a control system via a triggering signal;

at least one signal transmitter for detecting and transmitting the position of the actuator for the purpose of producing corresponding two-channel signals; and

at least one signal transmitter for detecting and transmitting at least one of the positions of the drive and the locking element for the purpose of producing corresponding two-channel signals;

wherein an electric interface circuit is provided in the housing for connection to a data bus, the interface circuit converting the signals from the signal transmitters and the triggering signal into the data protocol of the data bus and generating signals therefrom, respectively.

Further embodiments, adavantages and objects of the invention are evident from the following description.

### BRIEF DESCRIPTION OF THE DRAWING

An embodiment of a safety tumbler is illustrated schematically in the attached figure.

### DESCRIPTION OF A PREFERRED EMBODIMENT

The said safety tumbler comprises a housing 1 which is fastened to a stationary component A provided with a movable member B like a door, flap or the like whose open or closed position is to be monitored and maintained via a control system, and comprises a safety switch 2 which can be actuated by means of an actuator 3 which itself is mounted on movable and can be introduced into a slot 4 of the safety switch 2 in order to actuate the latter. In the drawing component A and element B are shown overlapping each other with respect to the paper plane. Element B may be hinged to the stationary component A at its right hand lateral side (not shown) may be opened by pivoting it out of the paper plane. However, other arrangements of component A and element B may be possible.

The safety switch 2 comprises at least one signal transmitter 5, here in the form of make and/or break contacts which can be closed or opened in accordance with their function by introduction of the actuator 3 into the slot 4 as a consequence movable member B being closed or can be opened or closed in accordance with their function by withdrawing the actuator 3 from the slot 4 as a consequence of the movable member B being opened. However, the signal transmitter or transmitters 5 can also be other mechanical or contactless contacts or sensors (on an optical, magnetic, inductive or capacitative basis) which detect the position of the actuator 3.

Furthermore, a drive 6 is provided in the housing 1 for a locking element 7 which can be brought into engagement with the actuator 3 so as to have the effect that the actuator 3 cannot be removed from the safety switch 2. The drive 6 can be a motor, a solenoid or the like, while the locking element 7 can, for example, be a displaceable or rotatable latch or the like.

Furthermore, at least one signal transmitter 8 is provided in the housing 1, which signal transmitter 8 can be designed in the form of one or more mechanical or contactless contacts or sensors (on an optical, magnetic, inductive or capacitative basis) in order to detect the position of the drive 6 and/or of the locking element 7.

The signal transmitters 5, 8 supply two-channel and, therefore, redundant signals.

Finally, an electric interface circuit 9 for connecting the safety tumbler to a data bus 10 is arranged in the housing 1, the interface circuit 9 being electrically connected to the individual signal transmitters 5, 8. Possible data buses 10 are, in particular, standard buses, such as AS-i, Profibus, Device-Net, Ethernet-TCP/IP, Interbus-S or similar serial bus systems, specifically in each case with their additional protocols or mechanisms satisfying safety requirements; in the case of AS-i this would be AS-i Safety at Work, and ProfiSafe in the case of Profibus.

The signals of the signal transmitters 5, 8 are converted by the interface circuit 9 into the data protocol of the data bus 10.

The drive 6 is also connected via a triggering line 11 to the interface circuit 9, the latter generating from a signal supplied by the control system or safety control system of an associated machine via the data bus 10 a triggering signal for the drive 6, which signal is supplied to the drive via the triggering line 11.

The data bus 10 can comprise one or two cables, in the latter case data and power being transmitted separately in each case, while in the former case data and power are transmitted together. The interface circuit 9 is connected to the respective bus cable via a corresponding interface 12, as a result of which the connection of the safety tumbler is considerably simplified and costs considerably less.

The interface circuit 9 can be designed as a chip or can be constructed from a plurality of electronic components.

What is claimed is:

1. A safety tumbler for a member movable between a closed and an open position, said tumbler comprising:
a housing with at least one safety switch provided with an actuator and a locking element whose locking function can be activated via a drive triggerable by a control system via a triggering signal;
at least one signal transmitter for detecting and transmitting the position of the actuator for the purpose of producing corresponding two-channel signals; and
at least one signal transmitter for detecting and transmitting at least one of the positions of the drive and the locking element for the purpose of producing corresponding two-channel signals;
wherein an electric interface circuit is provided in the housing for connection to a data bus, the interface circuit converting the signals from the signal transmitters into the data protocol of the data bus (10) and generating the triggering signal from the data protocol of the data bus (10).

2. The safety tumbler according to claim 1, wherein the electric interface circuit is designed as a chip.

3. The safety tumbler according to claim 1, wherein the electric interface circuit (9) is constructed from electronic components.

4. The safety tumbler according to claim 1, wherein the signal transmitters each comprise one or more mechanical or contactless contacts or sensors.

5. The safety tumbler according to claim 1, wherein the electric interface circuit is designed for transmitting power from the data bus to the safety tumbler in order to supply it with power.
